(19) United States
(12) Patent Application Publication
(10) Pub. No.: US 2018/0281630 A1
(43) Pub. Date: Oct. 4, 2018

(54) CONVEYANCE SEAT

(71) Applicant: TOYOTA BOSHOKU KABUSHIKI KAISHA, Aichi (JP)

(72) Inventors: Teruyuki SHIMIZU, Aichi (JP); Kenji FURUKAWA, Aichi (JP)

(73) Assignee: TOYOTA BOSHOKU KABUSHIKI KAISHA, Aichi (JP)

(21) Appl. No.: 15/939,865

(22) Filed: Mar. 29, 2018

(30) Foreign Application Priority Data
Apr. 3, 2017 (JP) 2017-073626

(51) Int. Cl. B60N 2/16; B60N 2/30; B60N 2/20

(52) U.S. Cl. CPC B60N 2/1615; B60N 2/20; B60N 2/3065

(57) ABSTRACT

A vehicle seat is provided. The vehicle seat is displaceable between a “seating position” and a “storage position”. The vehicle seat includes a side frame, a front lifter link, and a rear lifter link. An upper end of the front lifter link is situated closer to a front side of the vehicle seat than a lower end of the front lifter link is when the side frame is placed in the seating position. An upper end of the rear lifter link is situated closer to the front side of the vehicle seat than a lower end of the rear lifter link is when the side frame is placed in the seating position.

### CROSS-REFERENCE TO RELATED APPLICATIONS

This application claims the benefit of Japanese Patent Application No. 2017-073626 filed Apr. 3, 2017 in the Japan Patent Office, the entire disclosure of which is incorporated herein by reference.

### BACKGROUND

The present disclosure relates to a vehicle seat used in a vehicle.

For example, Published Japanese Translation of PCT International Publication for Patent Application No. 2009-523090 (Patent Document 1) discloses a vehicle seat that is pivotable between a seating position and a storage position by a use of a four-joint link mechanism. The “seating position” is a position of a seat where a user can be seated on the seat. The “storage position” is a position of a seat that is displaced rearward and downward of the seating position.

Specifically, the aforementioned four-joint link mechanism comprises side frames that extend along the front-rear axis of the seat; and two lifter links, the first one pivotably coupled to the front end of the side frames and the second one pivotably coupled to the rear end of the side frames. A lower end of each of the lifter links is pivotably coupled to a floor or other part of a vehicle.

### SUMMARY

The vehicle seat is displaced rearward by a pivotal displacement of each lifter link from the seating position to the storage position. In other words, the greater an angle of pivotal displacement of each lifter link becomes, the more the vehicle seat is displaced rearward.

Some vehicles require a large amount of rearward displacement of the vehicle seat. The “amount of rearward displacement” is a displaced distance of the vehicle seat along the front-rear axis of the seat when the vehicle seat is displaced from the seating position to the storage position.

Preferably, one aspect of the present disclosure provides a vehicle seat that can produce a large amount of rearward displacement.

The vehicle seat in the present disclosure is displaceable between a seating position and a storage position, the storage position being situated rearward and downward of the seating position. The vehicle seat comprises a side frame, a front lifter link, and a rear lifter link. The side frame is a part of a cushion frame and extends along a front-rear axis of the seat. An upper end of the front lifter link is pivotably coupled to the side frame, and a lower end of the front lifter link is pivotably coupled to a vehicle body. The front lifter link is situated forward relative to the rear lifter link. An upper end of the rear lifter link is pivotably coupled to the side frame, and a lower end of the rear lifter link is pivotably coupled to a vehicle body. The rear lifter link is situated rearward relative to the front lifter link. The upper end of the front lifter link is situated closer to a front side of the vehicle seat than the lower end of the front lifter link is when the side frame is placed in the seating position. The upper end of the rear lifter link is situated closer to the front side of the vehicle seat than the lower end of the rear lifter link is when the side frame is placed in the seating position.

According to this configuration, the front lifter link and the rear lifter link are pivotally displaced from the front side of the vehicle seat to a rear side of the vehicle seat respectively across a front and a rear imaginary vertical line in the present disclosure. The front imaginary vertical line passes a pivotal axis of the lower end of the front lifter link; the rear imaginary vertical line passes a pivotal axis of the lower end of the rear lifter link.

This allows angles of pivotal displacement of the front lifter link and the rear lifter link to be greater than those of the vehicle seat disclosed in Patent Document 1. The vehicle seat of the present disclosure can accordingly produce a large amount of rearward displacement.

In the vehicle seat disclosed in Patent Document 1, each link is already situated in the rear side of the respective imaginary vertical line when an occupant is seated in the seat. The angle of pivotal displacement is thus less than that of the vehicle seat according to the present disclosure. In other words, the amount of rearward displacement of the vehicle seat disclosed in Patent Document 1 is less than the amount of rearward displacement of the vehicle seat according to the present disclosure.

The present disclosure may also be configured as below.

Desirably, the side frame includes a first end and a second end. The first end is close to a front of the vehicle relative to the second end. The first end of the side frame is situated more upwardly than the second end of the side frame is in the seating position, and a front lifter link length is greater than a rear lifter link length.

This causes a front end of a cushion frame to be situated higher than a rear end of the cushion frame in the seating position, which enables an appropriate distribution of contact surface pressure between the occupant and a seat cushion.

The front lifter link length is a distance between a center of an upper joint and a center of a lower joint of the front lifter link. The rear lifter link length is a distance between a center of an upper joint and a center of a lower joint of the rear lifter link.

Desirably, a rear link angle is greater than a front link angle in the seating position. The amount of rearward displacement of the upper end of the rear lifter link is accordingly substantially equal to the amount of rearward displacement of the upper end of the front lifter link.

Accordingly, an imaginary line that passes an upper-end pivot center of the front lifter link and an upper-end pivot center of the rear lifter link can therefore be substantially parallel to, for example, a floor panel of the vehicle when the cushion frame is placed in the storage position.

A front link angle is an angle of a first imaginary line, which passes the center of the upper joint and the center of the lower joint of the front lifter link, relative to a first vertical line passing through the center of the lower joint of the front lifter link.

A rear link angle is an angle of a second imaginary line, which passes the center of the upper joint and the center of the lower joint of the rear lifter link relative to a second vertical line passing through the center of the lower joint of the rear lifter link.

### BRIEF DESCRIPTION θF THE DRAWINGS

Embodiments of the present disclosure will be described hereinafter by way of example with reference to the accompanying drawings, in which:

FIG. 1 is a diagram showing an outline of a vehicle seat according to an embodiment;

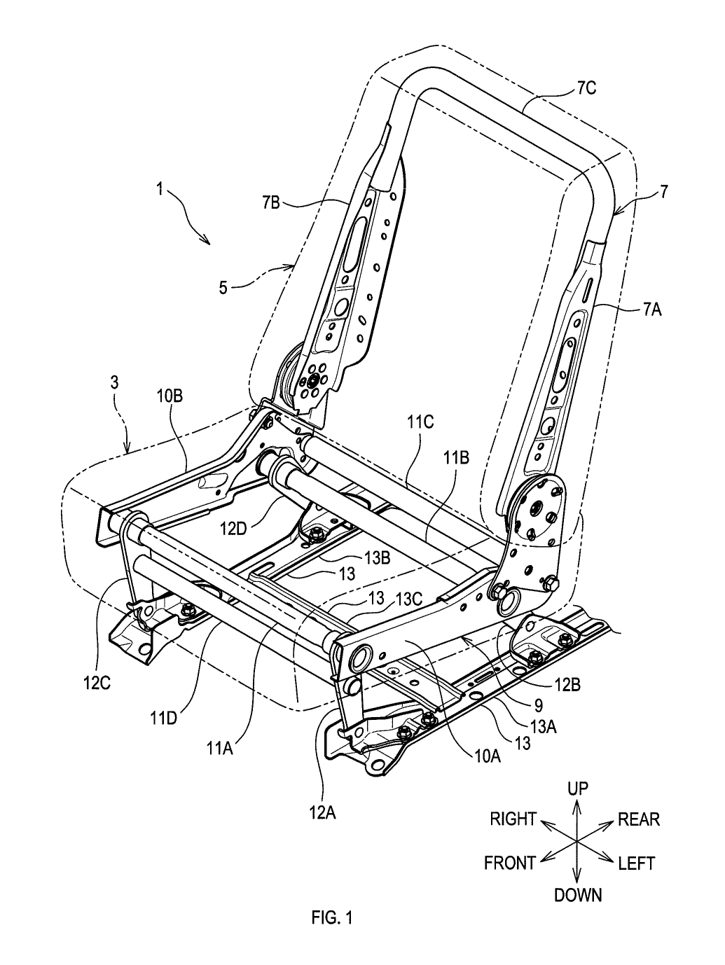

FIG. 2 is an explanatory diagram showing movements of a displacement mechanism of the vehicle seat according to the embodiment;

FIG. 3 is an explanatory diagram showing movements of the displacement mechanism of the vehicle seat according to the embodiment;

FIG. 4 is an explanatory diagram showing movements of the displacement mechanism of the vehicle seat according to the embodiment; and

FIG. 5 is an explanatory diagram showing movements of the displacement mechanism of the vehicle seat according to the embodiment.

### DETAILED DESCRIPTION θF THE PREFERRED EMBODIMENTS

An “embodiment” explained hereinafter shows one example of embodiments that belong to the technical scope of the present disclosure. In other words, matters to specify the invention recited in the claims are not limited to specific configurations or structures that are shown in the embodiments explained hereinafter.

Arrows and other marks that indicate directions on each drawing are made for easy understanding of relationship between each drawing. Arrows and other marks (directions) labelled on each drawing do not limit the scope of the present disclosure.

1. Outline of Vehicle seat

A vehicle seat 1 according to the present embodiment comprises at least a seat cushion 3 and a seatback 5. The vehicle seat 1 may be a rear seat of a passenger car.

The seatback 5 supports the back of an occupant. A back frame 7 is a frame of the seatback 5. The back frame 7 comprises a left side frame 7A, a right side frame 7B, and an upper frame 7C.

The occupant is a passenger of a vehicle, or a user of the vehicle seat 1. In other words, the occupant might not be actually seated on the vehicle seat 1.

The left side frame 7A and the right side frame 7B are situated respectively in the left end and the right end of the seat and extend substantially vertically. The upper frame 7C couples an upper end of the left side frame 7A and an upper end of the right side frame 7B together.

A lower end of each of the left side frame 7A and the right side frame 7B, in other words, lower ends of the back frame 7, is coupled to the rear end of a cushion frame 9. The back frame 7 is coupled to the cushion frame 9 so as to be pivotable in the front-rear direction relative to the cushion frame 9.

2. Configuration of Cushion Frame

2.1 Outline of Cushion Frame

The seat cushion 3 supports the buttocks of the occupant. The cushion frame 9 is a frame of the seat cushion 3.

The cushion frame 9 comprises at least a left side frame 10A, a right side frame 10B, a first connecting rod 11A, a second connecting rod 11B, a third connecting rod 11C, front lifter links 12A and 12C (specifically, front-left lifter link 12A and front-right lifter link 12C), and rear lifter links 12B and 12D (specifically, rear-left lifter link 12B and rear-right lifter link 12D). The left side frame 10A and the right side frame 10B are situated respectively in the left side and the right side of the seat, and each extends along the front-rear axis of the seat.

The first to third connecting rods 11A to 11C extend along the seat-width axis and couple the left side frame 10A and the right side frame 10B together. The first connecting rod 11A couples a front end of the left side frame 10A and a front end of the right side frame 10B together.

The second connecting rod 11B and the third connecting rod 11C each couple a rear end of the left side frame 10A and a rear end of the right side frame 10B together.

The first connecting rod 11A and the second connecting rod 11B are rotatably coupled to the left side frame 10A and the right side frame 10B. In other words, each of the first connecting rod 11A and the second connecting rod 11B is rotatable about its own pivotal axis.

The third connecting rod 11C is disposed closer to the rear side of the seat than the second connecting rod 11B is. In addition, the third connecting rod 11C is fixed to the left side frame 10A and the right side frame 10B by welding, swaging, or other methods. The left side frame 10A, the right side frame 10B, and the first to third connecting rods 11A to 11C are preferably made of metal.

An upper end of each of the front-left lifter link 12A and the front-right lifter link 12C is fixed to the first connecting rod 11A. A lower end of each of the front-left lifter link 12A and the front-right lifter link 12C is pivotably coupled to the vehicle body.

In other words, the upper end of the front-left lifter link 12A and the upper end of the front-right lifter link 12C are pivotably coupled to the left side frame 10A and the right side frame 10B respectively via the first connecting rod 11A. The front-left lifter link 12A and the front-right lifter link 12C are situated between the left side frame 10A and the right side frame 10B, and the upper end of the front-left lifter link 12A and the upper end of the front-right lifter link 12C are fixed to the first connecting rod 11A by welding.

The lower end of the front-left lifter link 12A and the lower end of the front-right lifter link 12C are pivotably coupled to a foundation 13. The foundation 13 comprises a left base 13A, a right base 13B, and a bridge 13C. Note, the upper ends are nominally called “upper” ends for convenience with respect to the seating position, but may actually be rotated to below the lower ends in a storage position (not shown).

The left base 13A and the right base 13B each have a belt-like shape, which extends along the front-rear axis of the seat, and are respectively disposed in the left side and the right side of the seat and fixed to the floor panel or other part of the vehicle. The lower end of the front-left lifter link 12A and the lower end of the front-right lifter link 12C are pivotably coupled to the left base 13A and the right base 13B respectively.

The bridge 13C extends along the seat-width axis between the left base 13A and the right base 13B, and couples the base 13A to the base 13B. The bridge 13C and each base 13A and base 13B are integrated by welding.

The second connecting rod 11B is fixed to upper ends of the rear-left lifter link 12B and the rear-right lifter link 12D. A lower end of the rear-left lifter link 12B is pivotably coupled to the vehicle.

The rear-left lifter link 12B and the rear-right lifter link 12D are coupled to the left side frame 10A and the right side frame 10B respectively and to the vehicle in a manner similar to that of the front-left lifter link 12A.

To be specific, an upper end of the rear-left lifter link 12B and an upper end of the rear-right lifter link 12D are pivotably coupled to the left side frame 10A and the right side frame 10B respectively via the second connecting rod 11B. A lower end of the rear-left lifter link 12B and a lower end of the rear-right lifter link 12D are pivotably coupled to the left base 13A and the right base 13B respectively.

The front-left lifter link 12A and the front-right lifter link 12C are also coupled together via a fourth connecting rod 11D. Specifically, the fourth connecting rod 11D extends along the seat-width axis and couples an intermediate area (between the lower end and the upper end) of the front-left lifter link 12A to an intermediate area (between the lower end and the upper end) of the front-right lifter link 12C.

2.2 Displacement Mechanism of Seat Cushion (Cushion Frame)

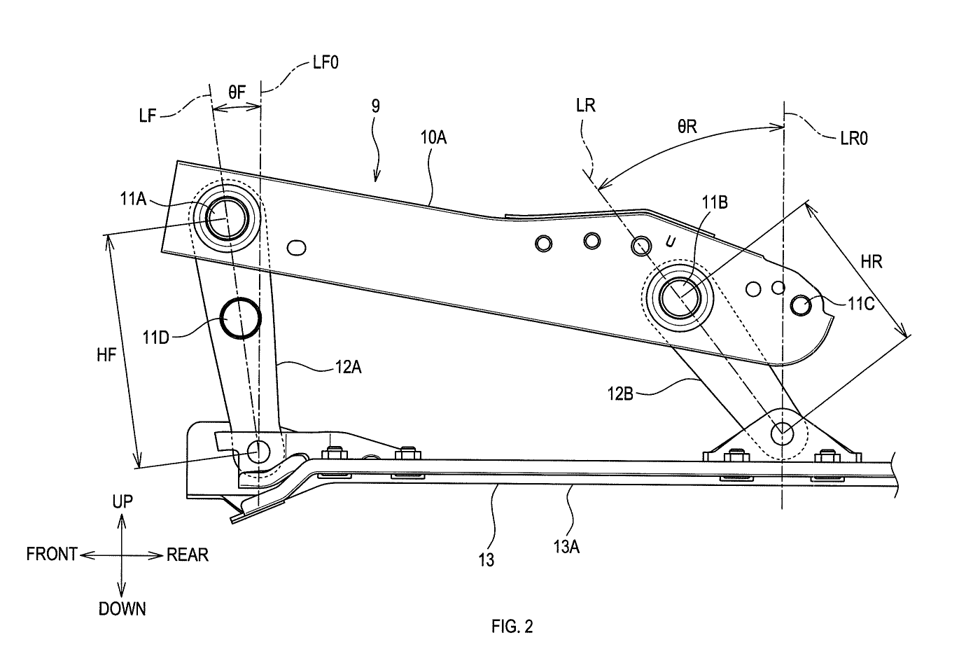

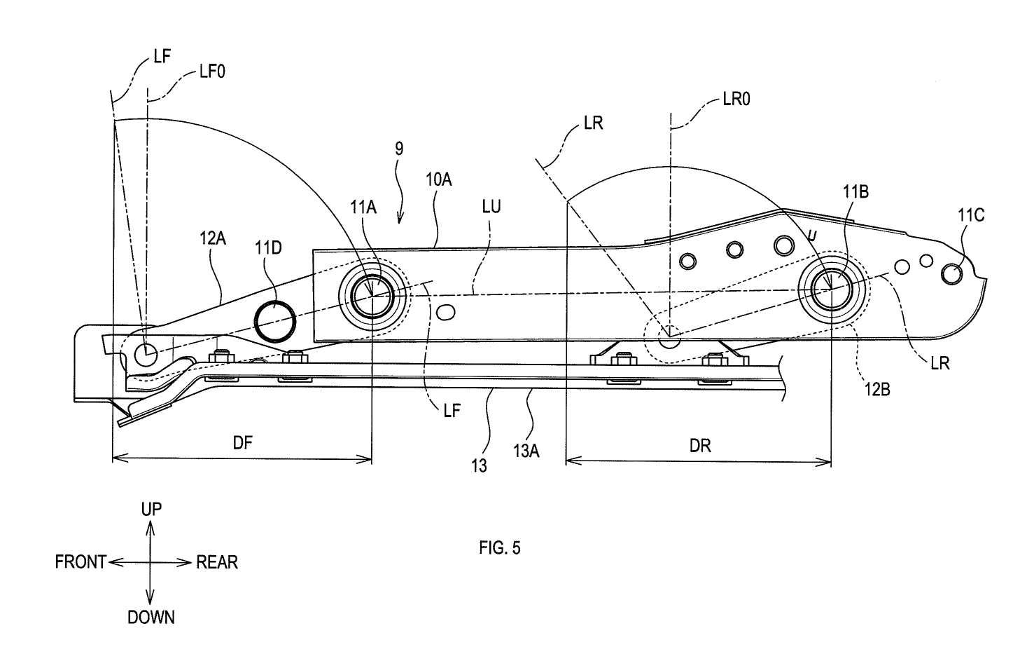

A displacement mechanism displaces the seat cushion 3, in other words, the cushion frame 9 moves from a seating position (see FIG. 2) to a storage position (see FIG. 5).

The “seating position” is a position of the vehicle seat 1 where the occupant can be seated on the seat cushion 3. The “storage position” is a position of the vehicle seat 1 where the seat cushion 3 is displaced rearward and downward from the seating position.

The displacement mechanism comprises two four-joint link mechanisms: a left four-joint link mechanism and a right four-joint link mechanism. Together, the two four-joint link mechanisms comprise: the left side frame 10A, the right side frame 10B, the front-left lifter link 12A, the front-right lifter link 12C, the rear-left lifter link 12B, and the rear-right lifter link 12D.

FIG. 2 shows the left four-joint link mechanism disposed in the left side of the seat. Specifically, the left four-joint link mechanism in the left side of the seat comprises: the left side frame 10A, the front-left lifter link 12A, and the rear-left lifter link 12B.

The right four-joint link mechanism is substantially a mirror image of the left four-joint lift mechanism, is disposed in the right side of the seat and comprises: the right side frame 10B, the front-right lifter link 12C, and the rear-right lifter link 12D. Hereinafter, the left four-joint link mechanism in the left side of the seat will be discussed in detail.

When the cushion frame 9 is placed in the seating position, per FIG. 2, the front-left lifter link 12A and the rear-left lifter link 12B are “standing ” with their upper ends situated slightly closer to the front side of the seat than the lower ends are. In other words, the front-left lifter link 12A and rear-left lifter link 12B each lean/tilt forward slightly.

Also when the cushion frame 9 is placed in the seating position, a front center line LF tilts forward relative to a front vertical line LF0 and a rear center line LR tilts forward relative to a rear vertical line LR0 as shown in FIG. 2

The front center line LF is an imaginary line that passes a center of the upper joint and a center of the lower joint of the front-left lifter link 12A, and rotates as the front-left lifter link 12A rotates. The center of the upper joint intersects a left-right axis of the first connecting rod 11A. Optionally, the front center line LF may intersect a left-right axis of the fourth connecting rod 11D, as shown in FIG. 2. The front vertical line LF0 is an imaginary vertical line that passes through the center of the lower joint of the front-left lifter link 12A.

The rear center line LR is an imaginary line that passes a center of the upper joint and a center of the lower joint of the rear-left lifter link 12B. The rear vertical line LR0 is an imaginary vertical line that passes the center of the lower joint of the rear-left lifter link 12B.

When the cushion frame 9 is placed in the seating position, a rear link angle θR is greater than a front link angle θF. The front link angle θF is an angle of rotation the front center line LF relative to the front vertical line LF0. Counterclockwise rotation in FIG. 2 is arbitrarily defined as positive rotation. Similarly, the rear link angle θR is an angle of rotation of the rear center line LR relative the rear vertical line LR0.

A front-lifter-link length HF is greater than a rear-lifter-link length HR. The front-lifter-link length HF is a distance between the center of the upper joint and the center of the lower joint of the front-left lifter link 12A. A rear-lifter-link length HR is a distance between the center of the upper joint and the center of the lower joint of the rear-left lifter link 12B.

3. Displacement of Cushion Frame (Displacement Mechanism) and Feature of Displacement

In the displacement mechanism according to the present embodiment, the rear-left lifter link 12B functions as “a driving link with an upper end that is pivotally displaced about its lower end due to a rotational force”, and the front-left lifter link 12A serves as a subordinate link that follows the pivotal displacement of the rear-left lifter link 12B. In one embodiment, the rear-right lifter link 12D may also be a driving link.

The rear-left lifter link 12B preferably receives a rotational force from the second connecting rod 11B. The second connecting rod 11B preferably rotates due to a rotational force from a driving device (not shown) preferably disposed in the cushion frame 9. The driving device comprises a deceleration mechanism that includes an electric motor and gear wheels. The driving device may rotate the second connecting rod 11B relative to the left side frame 10A, and the second connecting rod 11B may be welded (directly or indirectly) to the rear-left lifter link 12B. Thus, the rear-left lifter link 12B is rotated relative to the left side frame 10A (about the left-right axis of the second connecting rod 11B).

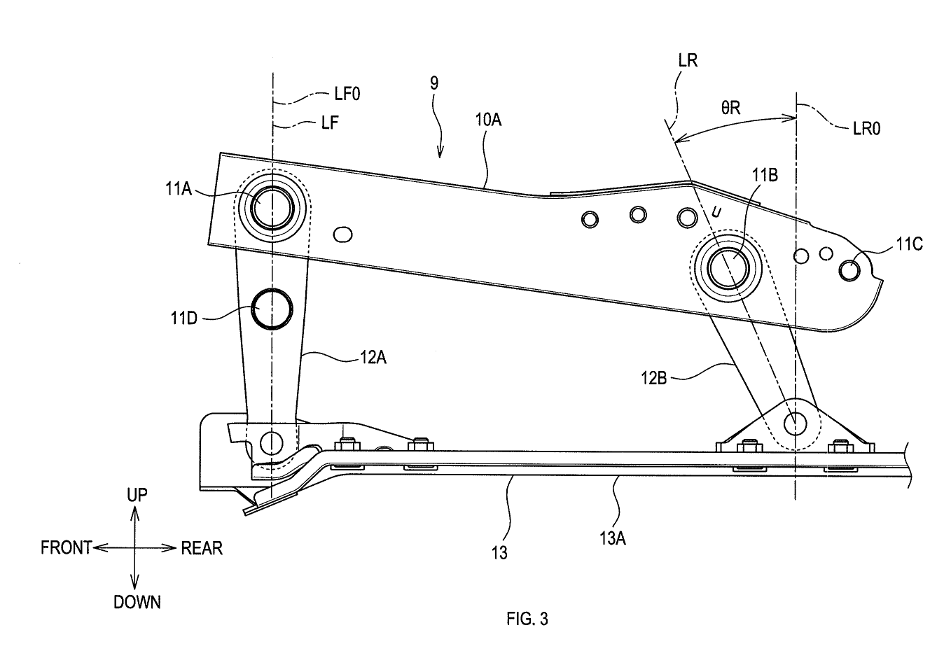

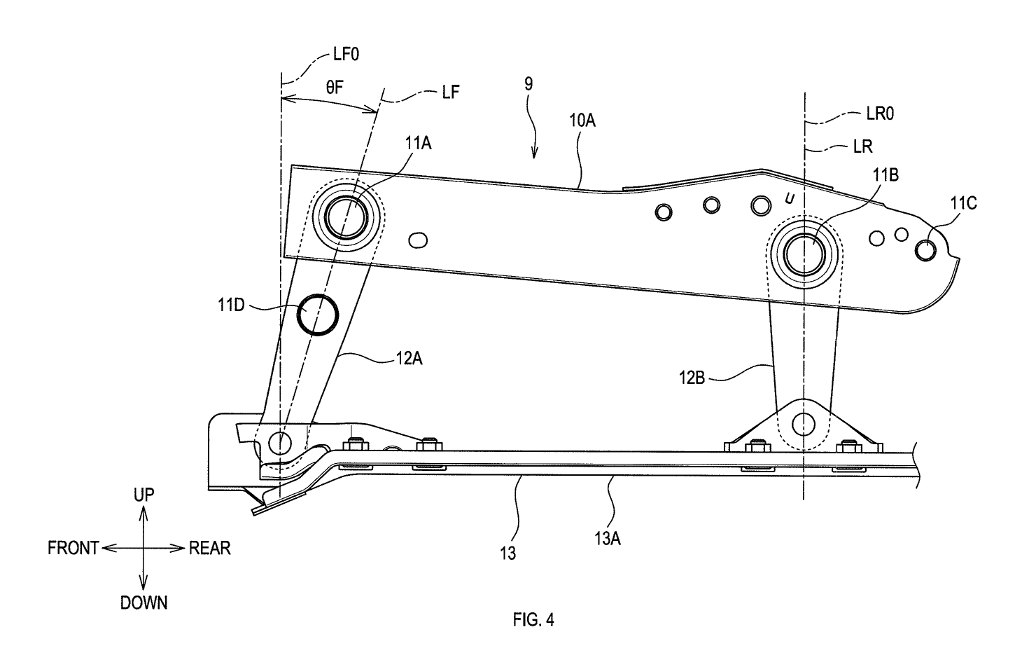

The cushion frame 9 is displaced from the seating position to the storage position as shown in FIG. 2, FIG. 3, FIG. 4, and FIG. 5 (in an ascending order) when the second connecting rod 11B rotates in a first direction (in a clockwise direction from FIG. 2 to FIG. 3). Alternatively, the cushion frame 9 is displaced from the storage position to the seating position as shown in FIG. 5, FIG. 4, FIG. 3, and FIG. 2 (in a descending order) when the second connecting rod 11B rotates in a second direction that is opposite of the first direction.

As shown in FIG. 2, the front end of the cushion frame 9 is situated higher than the rear end of the cushion frame 9 when the cushion frame 9 is placed in the seating position. As the pivotal movement of the rear-left lifter link 12B is subordinately followed by the pivotal movement of the front-left lifter link 12A, the displacement mechanism (the left four-joint link mechanism) transforms as shown in FIG. 3, FIG. 4, and FIG. 5 in the ascending order.

More specifically, the front-left lifter link 12A is pivotally displaced from the front side of the seat to the rear side of the seat across the front vertical line LFo as shown in FIG. 2, FIG. 3, and FIG. 4 in the ascending order. Similarly, the rear-left lifter link 12B is pivotally displaced from the front side of the seat to the rear side of the seat across the rear vertical line LR0 as shown in FIG. 3, FIG. 4, and FIG. 5 in the ascending order.

In the present embodiment, since the rear link angle θR is greater than the front link angle θF in the seating position, the front-left lifter link 12A crosses the front vertical line LF0 faster than the rear-left lifter link 12B passes the rear vertical line LR0 as the seat cushion 3 changes from a seated position to a storage position.

Accordingly, in the present embodiment, an angle of pivotal displacement of the front-left lifter link 12A and an angle of pivotal displacement of the rear-left lifter link 12B are greater than those of the vehicle seat disclosed in Patent Document 1. Since the greater the angles of pivotal displacement of the front-left lifter link 12A and the rear-left lifter link 12B are, the greater the rearward displacement of the vehicle seat 1 becomes, a large amount of rearward displacement can be produced in the present embodiment.

The situation defined as “when the front-left lifter link 12A passes the front vertical line LF0” is that the front center line LF coincides with the front vertical line LF0 and the front-left lifter link 12A is placed upright substantially at 90 degrees.

The situation defined as “when the rear-left lifter link 12B passes the rear vertical line LR0” is that the rear center line LR coincides with the rear vertical line LR0 and the rear-left lifter link 12B is placed upright substantially at 90 degrees.

As shown in the seating positon of FIG. 2, the front end of the left side frame 10A is situated more upwardly than the rear end of the side frame 10A. This causes the front end of the cushion frame 9 to be situated higher than the rear end of the cushion frame 9 in the seating position, which enables an appropriate distribution of contact surface pressure between the occupant and the seat cushion 3.

The rear link angle θR in the seating position is greater than the front link angle θF in the seating position; and the front-lifter-link length HF is greater than the rear-lifter-link length HR.

Accordingly, as shown in FIG. 5, an amount of rearward displacement DR of the upper end of the rear-left lifter link 12B is substantially equal to an amount of rearward displacement DF of the upper end of the front-left lifter link 12A. An upper-end imaginary line LU can therefore be substantially horizontal when the cushion frame 9 is placed in the storage position.

The upper-end imaginary line LU is an imaginary line that passes an upper-end pivot center of the front-left lifter link 12A and an upper-end pivot center of the rear-left lifter link 12B. The situation defined as “when the upper-end imaginary line LU is substantially horizontal” is, for example, that the cushion frame 9 is substantially parallel to a floor panel or other floor components of the conveyance. In FIG. 5, if the upper-end imaginary line LU is substantially in a front-rear direction, then the cushion frame 9 is substantially horizontal.

The front-left lifter link 12A is coupled to the front-right lifter link 12C via the fourth connecting rod 11D. This reduces malfunction, for example, that the front-left lifter link 12A is buckled due to a downward load on the cushion frame 9.

<Other Embodiments>

Although the vehicle seat 1 is attached and fixed to the vehicle via the foundation 13 in the aforementioned embodiment, the present disclosure is nevertheless not limited to this configuration. For example, there may be no foundation 13.

Although the front-lifter-link length HF is greater than the rear-lifter-link length HR in the aforementioned embodiment, the present disclosure is nevertheless not limited to this configuration. For example, the front-lifter-link length HF may be equal to the rear-lifter-link length HR.

Although, in the left side frame 10A and the right side frame 10B, their front ends are situated more upwardly than their rear ends are in the seating position in the aforementioned embodiment, the present disclosure is nevertheless not limited to this configuration. For example, the front ends and the rear ends of the left side frame 10A and the right side frame 10B may be situated at substantially the same height in the seating position.

Although the rear link angle θR is greater than the front link angle θF in the seating position in the aforementioned embodiment, the present disclosure is nevertheless not limited to this configuration. For example, the rear link angle θR and the front link angle θF may be substantially the same in the seating position.

Although the intermediate area of the front-left lifter link 12A (in the direction of extension of the front-left lifter link 12A) is coupled to the intermediate area of the front-right lifter link 12C (in the direction of extension of the front-right lifter link 12C) via the fourth connecting rod 11D in the aforementioned embodiment, the present disclosure is nevertheless not limited to this configuration.

For example, there may be no fourth connecting rod 11D. Alternatively, the upper ends of the front-left lifter link 12A and the front-right lifter link 12C or the lower ends of the front-left lifter link 12A and the front-right lifter link 12C may be coupled via the fourth connecting rod 11D.

The aforementioned embodiments describe a rear seat of a passenger car. However, utilization of the present disclosure is not limited thereto. The present disclosure may be used for seats of other automobiles, or seats of other vehicles such as railway vehicles, vessels, and aircrafts.

In addition, the present disclosure is not limited to the aforementioned embodiments as long as it falls within the spirit of the invention described in the claims. Accordingly, the present disclosure may be configured in combination of at least two of the aforementioned embodiments.

What is claimed is:

1. A vehicle seat that is displaceable between a seating position and a storage position, the storage position being situated rearward and downward of the seating position, the vehicle seat comprising:
a side frame that is a part of cushion frame Arid extends along a front-rear axis of the seat;
a front lifter link arranged such that an upper end of the front lifter link is pivotably coupled to the side frame and a lower end of the front lifter link is pivotably coupled to a vehicle body, the front lifter link being situated forward relative to a rear lifter link; and
the rear lifter link arranged such that an upper end of the rear lifter link is pivotably coupled to the side frame and a lower end of the rear lifter link is pivotably coupled to a vehicle body, the rear lifter link being situated rearward relative to the front lifter link,
the upper end of the front lifter link being situated closer to a front side of the vehicle seat than the lower end of the front lifter link is when the side frame is placed in the seating position, and
the upper end of the rear lifter link being situated closer to the front side of the vehicle seat than the lower end of the rear lifter link is when the side frame is placed in the seating position.

2. The vehicle seat according to claim 1, wherein,
the side frame includes a first end and a second end, the first end being close to a front of the vehicle relative to the second end, and
when a front lifter link length is a distance between a center of an upper joint and a center of a lower joint of the front lifter link, and when a rear lifter link length is a distance between a center of an upper joint and a center of a lower joint of the rear lifter link, the first end of the side frame is situated more upwardly than the second end of the side frame in the seating position, and the front lifter link length is greater than the rear lifter link length.

3. The vehicle seat according to claim 2, wherein
when a front link angle is an angle of a first imaginary line, which passes the center of the upper joint and the center of the lower joint of the front lifter link, relative to a first vertical line passing through the center of the lower joint of the front lifter link, and when a rear link angle is an angle of a second imaginary line, which passes the center of the upper joint and the center of the lower joint of the rear lifter link, relative to a second vertical line passing through the center of the lower joint of the rear lifter link, the rear link angle is greater than the front link angle in the seating position.
